(19) United States
(12) Patent Application Publication
(10) Pub. No.: US 2015/0127180 A1
(43) Pub. Date: May 7, 2015

(54) METHOD FOR GENERATING INFORMATION FOR POWER GRID OPTIMIZATION, AND AGENT DEVICE

(71) Applicant: KOREA INSTITUTE OF ENERGY RESEARCH, Daejeon (KR)

(72) Inventors: Sea Seung Oh, Daejeon (KR); Su Yong Chae, Daejeon (KR); Yu jin Song, Daejeon (KR); Hak Guen Jeong, Daejeon (KR); Yoon Dong Sung, Daejeon (KR)

(21) Appl. No.: 14/397,655

(22) PCT Filed: Aug. 13, 2013
(86) PCT No.: PCT/KR2013/007261

§ 371 Date: Oct. 29, 2014

(30) Foreign Application Priority Data
Aug. 29, 2012 (KR) 10-2012-0095202

(51) Int. Cl. H02J 3/12; G05F 1/66; G05B 15/02

(52) U.S. Cl. CPC H02J 3/12; G05B 15/02; G05F 1/66
USPC 700/291; 700/286

(57) ABSTRACT

The present invention relates to a technique for generating information for power grid optimization. The present invention allows information for power grid optimization to be generated by another agent device even when an agent device fails by providing a technique for generating the information for power grid optimization through one or more agent devices from among a plurality of agent devices which are connected horizontally, and distributing and applying the generated information with other agent devices.

### TECHNICAL FIELD

The present invention relates to a technology for generating power grid optimization information.

### BACKGROUND ART

A power grid includes a number of power consuming devices and a number of power supplying devices connected like a spider's web. In order to bring balance between demand and supply in such a power grid, control is conducted in connection with at least one device.

Such control commonly constitutes a pyramid-type control scheme. Such a control scheme will now be described in more detail: agent devices related to individual devices, which constitute the power grid, are positioned on the lower layer in such a control scheme, and a central management device, which controls them at the center, is positioned on the upper layer, so that the agent devices on the lower layer operate under the control of the upper layer.

Such a scheme is suited to adjust the balance between demand and supply in the power grid in terms of the fact that, under the control of a single central management device having a commanding right, relevant agent devices operate in a unified manner. However, such a scheme has a problem in that, if the central management device malfunctions, the entire system is paralyzed. In such a multi-staged vertical command control scheme, malfunctioning of a management device or an agent device at an intermediate stage, if not malfunctioning of the central management device, makes it impossible to control devices at the lower stage.

Such a problem could be fatal to a power grid. Malfunctioning of a single central management device could lead to a situation of overall blackout, and malfunctioning of a management device at an intermediate stage, if less serious than the former, could lead to escaping of devices, which recognize the management device as an upper-layer control device, out of the control of the power grid.

### DETAILED DESCRIPTION OF THE INVENTION

On the above-mentioned background, an object of the present invention is to provide a technology for horizontally connecting a plurality of agent devices and enabling at least one agent device to manage the power grid. According to another aspect, an object of the present invention is to provide a technology for generating power grid optimization information by at least one agent device among a plurality of agent devices connected horizontally and distributing the information to other agent devices so as to be applied.

In order to accomplish the above-mentioned objects, the present invention provides, in an aspect, a method for generating power grid optimization information in a power grid management system including a plurality of agent devices, the method including: exchanging power grid optimization parameter information, which is held by each of the plurality of agent devices, between the plurality of agent devices; generating power grid optimization scheme information according to the exchanged power grid optimization parameter information by one agent device; proceeding with a negotiation process between the plurality of agent devices in connection with the power grid optimization scheme information; and transmitting, when power grid optimization information is confirmed as a result of the negotiation process, the power grid optimization information to other agent devices by the one agent device, wherein the negotiation process proceeds in such a manner that the one agent device transmits the power grid optimization scheme information or modified power grid optimization scheme information to the other agent devices, and the other agent devices reply to the one agent device with opinion information indicating whether the other agent devices agree with the received optimization scheme information or not or indicating agreement with modification.

In another aspect, the present invention provides an agent device for generating power grid optimization information in a power grid management system including a plurality of agent devices, the agent device including: a power grid optimization parameter information transmitting/receiving unit configured to exchange power grid optimization parameter information with other agent devices; a power grid optimization scheme information generating unit configured to generate power grid optimization scheme information according to the exchanged power grid optimization parameter information; a negotiation process processing unit configured to proceed with a negotiation process with the other agent devices in connection with the power grid optimization scheme information; and a power grid optimization information transmitting unit configured to transmit, when power grid optimization information is confirmed as a result of the negotiation process, the power grid optimization information to the other agent devices, wherein the negotiation process proceeds in such a manner that the power grid optimization scheme information or modified power grid optimization scheme information is transmitted to the other agent devices, and opinion information indicating whether the other agent devices agree with the transmitted optimization scheme information or not or indicating agreement with modification is received from the other agent devices.

In still another aspect, the present invention provides a method for generating power grid optimization information in a power grid management system, which includes a plurality of agent devices, by an agent device, the method including: exchanging power grid optimization parameter information with other agent devices; generating power grid optimization scheme information according to the exchanged power grid optimization parameter information; proceeding with a negotiation process with the other agent devices in connection with the power grid optimization scheme information; and transmitting, when power grid optimization information is confirmed as a result of the negotiation process, the power grid optimization information to other agent devices, wherein the negotiation process proceeds in such a manner that the power grid optimization scheme information or modified power grid optimization scheme information is transmitted to the other agent devices, and opinion information indicating whether the other agent devices agree with the transmitted optimization scheme information or not or indicating agreement with modification is received from the other agent devices.

As described above, the present invention is advantageous in that power grid optimization information is generated by at least one agent device among a plurality of agent devices connected horizontally so that, even when one agent device malfunctions, another agent device can generate power grid optimization information.

### BRIEF DESCRIPTION OF THE DRAWINGS

FIG. 1 illustrates an exemplary connection between agent devices of a power grid management system according to an embodiment of the present invention.

FIG. 2 illustrates an exemplary connection between an agent device and management target devices according to an embodiment of the present invention.

FIG. 3 is a flowchart of a method for generating power grid optimization information by a power grid management system according to an embodiment of the present invention.

FIG. 4 illustrates an exemplary configuration of a power grid for explaining a process of generating power grid optimization scheme information.

FIG. 5 is a graph illustrating an exemplary power supply unit price of a system according to time.

FIG. 6 is a flowchart of a negotiation process in a power grid management system according to an embodiment of the present invention.

FIG. 7 is an internal block diagram of an agent device configured to generate power grid optimization information according to an embodiment of the present invention.

FIG. 8 is a flowchart of a method for generating power grid optimization information by an agent device according to an embodiment of the present invention.

### MODE FOR CARRYING OUT THE INVENTION

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. These terms are merely used to distinguish one structural element from other structural elements, and a property, an order, a sequence and the like of a corresponding structural element are not limited by the term. It should be noted that if it is described in the specification that one component is “connected,” “coupled” or “joined” to another component, a third component may be “connected,” “coupled,” and “joined” between the first and second components, although the first component may be directly connected, coupled or joined to the second component.

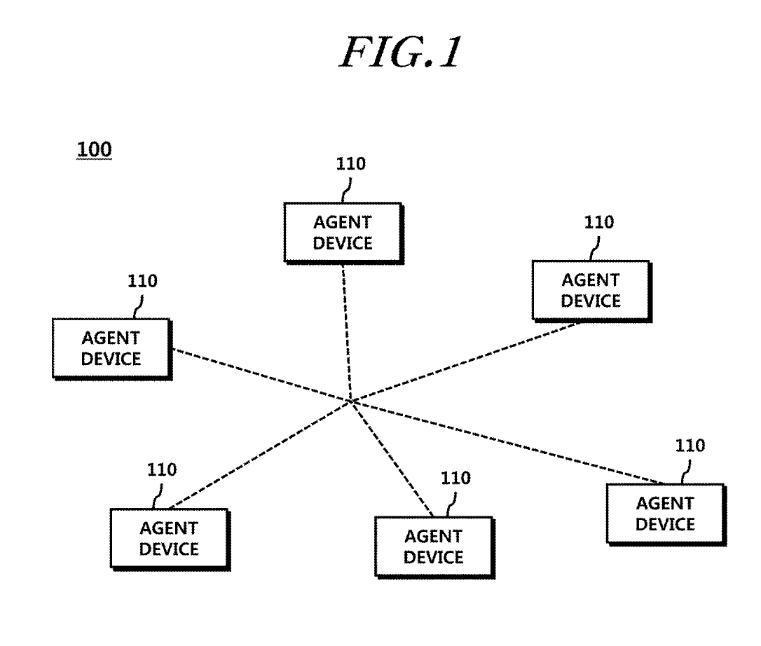

FIG. 1 illustrates an exemplary connection between agent devices of a power grid management system according to an embodiment of the present invention.

Referring to FIG. 1, agent devices 110 are connected horizontally in a power grid management system 100. The fact that the agent devices 110 are connected horizontally guarantees that, even when one agent device 110 malfunctions, the other agent devices 110, which are connected to each other, can exchange information.

The agent devices 110 are connected via a network inside the power grid management system 100. The network may be a wired communication network or a wireless communication network.

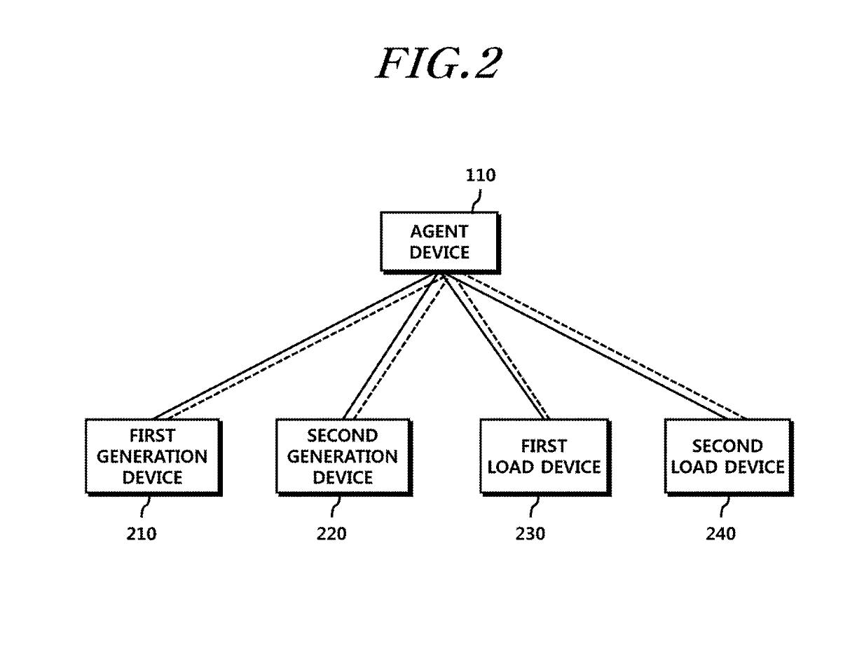

FIG. 2 illustrates an exemplary connection between an agent device 110 and management target devices according to an embodiment of the present invention.

Referring to FIG. 2, the agent device 110 is connected with a first generation device 210, a second generation device 220, a first load device 230, and a second load device 240 and manages the management target devices 210, 220, 230, 240. FIG. 2 is just an exemplary diagram for illustrating that the agent device 110 manages power supplying devices (generation devices etc.) or power consuming devices (load devices etc.); devices managed by the agent device 110 and target devices are not limited to generation devices or load devices; and the number of management target devices is not limited to the number of devices illustrated in FIG. 2.

Referring to FIG. 2, the agent device 110 is connected with management target devices 210, 220, 230, 240 by power lines (solid lines), and the agent device 110 is also connected to exchange information with the management target devices 210, 220, 230, 240 (dotted lines indicate network connections). Of course, the connection relationship between the agent device 110 and the management target devices 210, 220, 230, 240 is not limited to the connection relationship illustrated in FIG. 2; the agent device 110 may be connected with the management target devices by power lines only; and the agent device 110 may have only a network connection relationship, through which it can exchange information with the management target devices.

The agent device 110 may be in an intermediate position where it transfers power, which has been supplied from the power grid, to management target devices. Such positioning of the agent device 110 between the power grid and the management target devices enables the agent device 110 to measure the amount of power flowing into each management target device and to measure the amount of power flowing from each management target device to the power grid. Furthermore, the agent device 110 may further include a switch to release the connection between the management target devices and the power grid. For example, in order to interrupt power consumption of the second load device 240, the agent device 110 can use the switch to forcibly cut the connection between the second load device 240 and the power grid.

The agent device 110 can exchange information with the management target devices 210, 220, 230, 240 via the network. The information may simply be monitoring information related to monitoring of each management target device, or control information for controlling each management target device.

As the monitoring information, the agent device 110 may acquire information regarding the state of each management target device. Using such monitoring information, the agent device 110 can grasp which device is malfunctioning and which device is functioning normally. When a generation device is a management target device, furthermore, the agent device 110 can grasp the supply capability of the generation device, whether the generation device can supply additional power or not, etc.

The agent device 110 can also receive device detail information regarding each management target device from each management target device. As the device detail information, the agent device 110 can receive information regarding the generation efficiency, in the case of a generation device, and information regarding the function needed to calculate the generation unit price and, therefore, the generation price.

The agent device 110 can also receive, via the network, information regarding the amount of power consumed by each management target device or the amount of power supplied from each management target device. Each management target device may include a device for measuring the inflow/outflow of power, such as a meter, and the agent device 110 can receive information regarding the amount of inflow/outflow of power, measured by the measuring device, from each management target device.

The agent device 110 can also receive prediction information, which has been calculated or user-inputted, from each management target device. The prediction information may be power supply prediction information in connection with a power supplying device. For example, when the first generation device 210 is a sunlight generator, the first generation device 210 can acquire information regarding the weather of the area in which it is positioned, generate time period-based power supply prediction information using the weather information, and transmit the time period-based generation prediction information to the agent device 110. Of course, the agent device 110 may also directly generate such time period-based power supply prediction information regarding the sunlight generator.

When a first power consuming device is a management target device, the received prediction information may be power consumption prediction information. For example, the first load device 230 may manage information regarding the history of power consumption patterns for each day and time period, generate power consumption prediction information on the basis of the history information, and transmit the prediction information to the agent device 110. Of course, the agent device 110 may both manage such a history and directly generate the same power consumption prediction information.

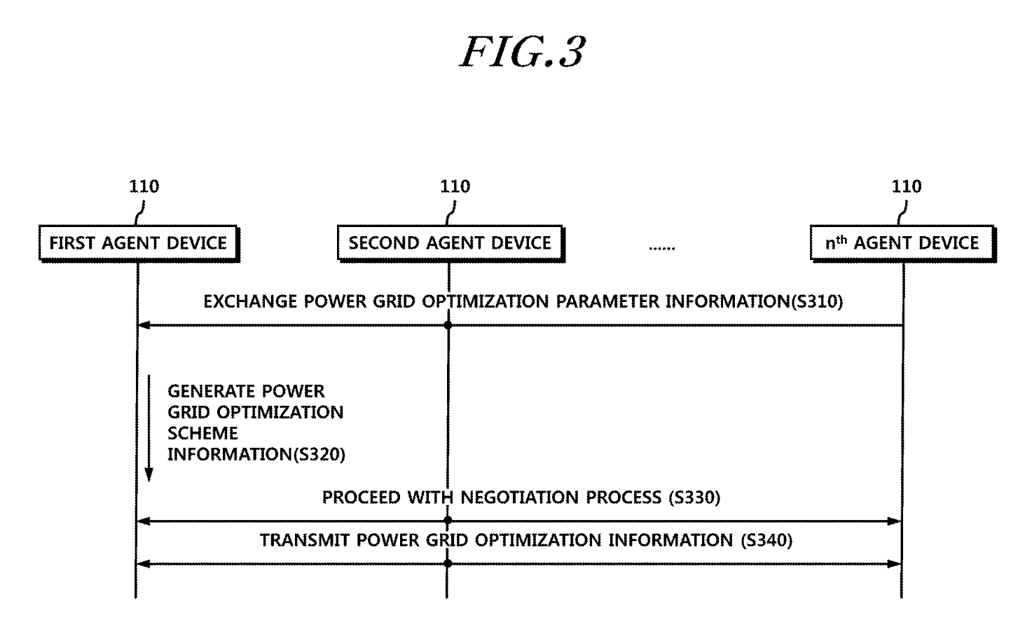

FIG. 3 is a flowchart of a method for generating power grid optimization information by a power grid management system according to an embodiment of the present invention.

Referring to FIG. 3, in a power grid management system 100, a plurality of agent devices exchange power grid optimization parameter information, which is held by each of the plurality of agent devices (S310).

The power grid optimization parameter information is information including values regarding parameters that can be used to generate power grid optimization information; the power grid optimization parameter information may include at least one of power consuming device information, power supplying device information, and power supply unit price information; the power consuming device information may include information regarding the state of at least one power consuming device, which constitutes the power grid, and power consumption prediction information; and the power supplying device information may include information regarding the state of at least one power supplying device, which constitutes the power grid, and power supply prediction information.

It will be assumed, as a specific example, that an agent device manages two power supplying devices, and another agent device manages two power consuming devices: the former agent device transmits power supply prediction information regarding the two power supplying devices or power supply unit price information to the latter agent device, and the latter agent device transmits power consumption prediction information regarding the two power consuming devices to the former agent device, so that the two agent devices acquire power grid optimization parameter information from each other.

After the plurality of agent devices exchange power grid optimization parameter information, one agent device (first agent device 110 in FIG. 3) generates power grid optimization scheme information on the basis of the exchanged power grid optimization parameter information (S320).

The power grid optimization scheme information is information indicating in which state each device, which constitutes the power grid, should be controlled to optimize the power grid. For example, power grid optimization scheme information may include data indicating which of the power supplying devices, which constitute the power grid, should supply the power grid with what amount of power, and may include data indicating what amount of power a controllable power consuming device should receive from the power grid.

In connection with generating the power grid optimization scheme information, one agent device (first agent device 110 in FIG. 3) can generate power grid optimization scheme information so as to minimize the power supply cost of the power grid.

A process of generating power grid optimization scheme information to minimize the power supply cost of the power grid will now be described in more detail.

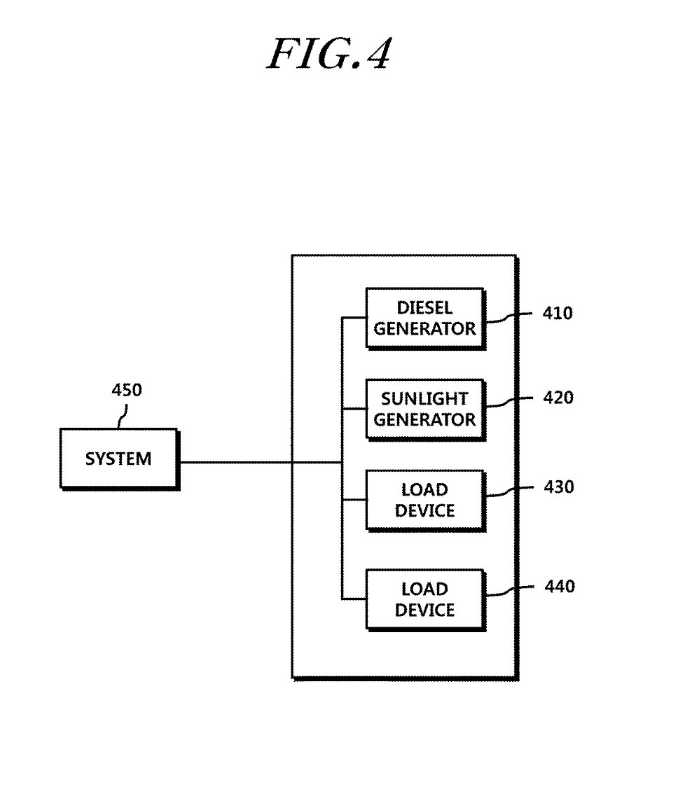

FIG. 4 illustrates an exemplary configuration of a power grid for explaining a process of generating power grid optimization scheme information.

Referring to FIG. 4, the power grid of the exemplary configuration is of a micro grid type and includes, on its own, one diesel generator 410, one sunlight generator 420, and two load devices 430, 440. The power grid can also be supplied with power from a system 450. Under these assumptions, a process of generating power grid optimization scheme information by one agent device (first agent device 110 in FIG. 3) so as to minimize the power supply cost of the power grid will now be described.

In order to find an optimization point at which the power supply cost is minimized, information regarding the power supply cost of each power supplying device is initially needed. First, the power supply cost of the diesel generator 410 can be calculated using the equation below:

F1(P1)=a*P1²+b*P1+c Equation 1

wherein P1 is the amount of generation by the diesel generator 410, and a, b, c are factor values of F1 determined by characteristics of the diesel generator 410.

The power supply cost of the sunlight generator 420 can be given as a constant as follows:

F2(P2)=Cpv Equation 2

wherein P2 is the amount of generation by the sunlight generator 420, and Cpv is a constant determined by characteristics of the sunlight generator 420.

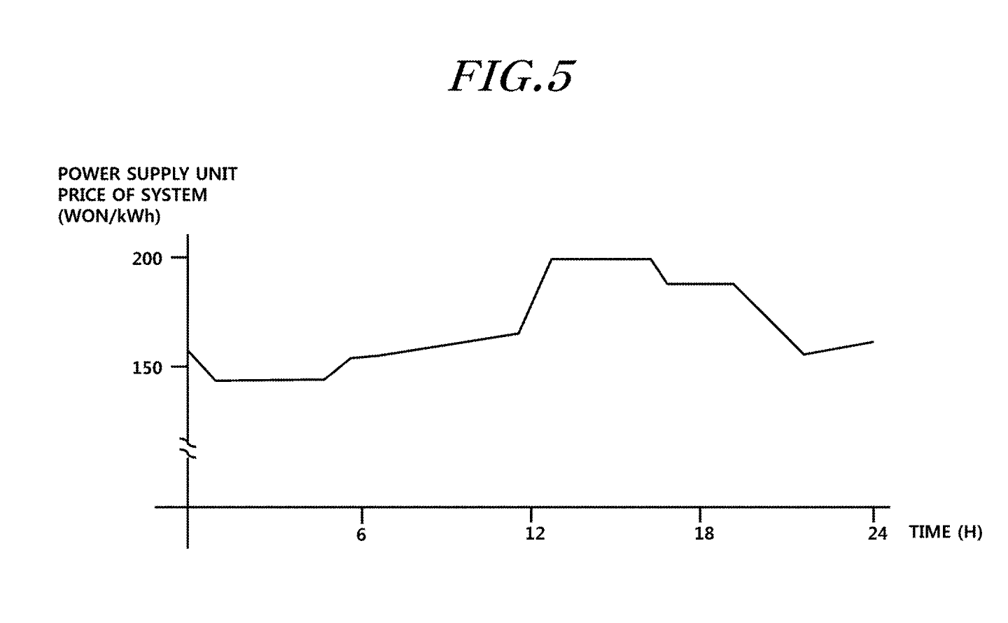

And the power supply cost F3(P3) of the system can be grasped from the time period-based power supply unit price information distributed in the electric power market. FIG. 5 is a graph illustrating an exemplary power supply unit price of a system according to time.

Besides the power supply cost information F1(P1), F2(P2), F3(P3) of devices that supply the power grid with power, one agent device (first agent device 110 in FIG. 3) is supposed to be aware of the power consumption amount information D1, D2 of load devices 430, 440, in order to generate power grid optimization scheme information for minimizing the power supply cost of the power grid. Since a balance is needed between demand and supply of power in the power grid, the following relation needs to be satisfied:

power supply amount(P1+22+23)=power consumption amount(D1+D2) Equation 3

In order for one agent device (first agent 110 in FIG. 3) to generate power grid optimization scheme information for minimizing the power supply cost of the power grid, a value that minimizes the power supply cost (Equation 4 below) is obtained under conditions that satisfy Equations 1 to 3 and the graph of FIG. 5.

Power supply cost=QᵢPi Equation 4

This process can be solved using already-known Quadratic programming, Interior Point Method, Genetic Algorithm, Particle Swam Optimization, etc.

After power grid optimization scheme information is generated by one agent device (first agent device 110 in FIG. 3) in this manner, a negotiation process regarding the power grid optimization scheme information proceeds among a plurality of agent devices (S330). During the negotiation process, the plurality of agent devices exchange negotiation information for deducing power grid optimization information on the basis of the power grid optimization scheme information.

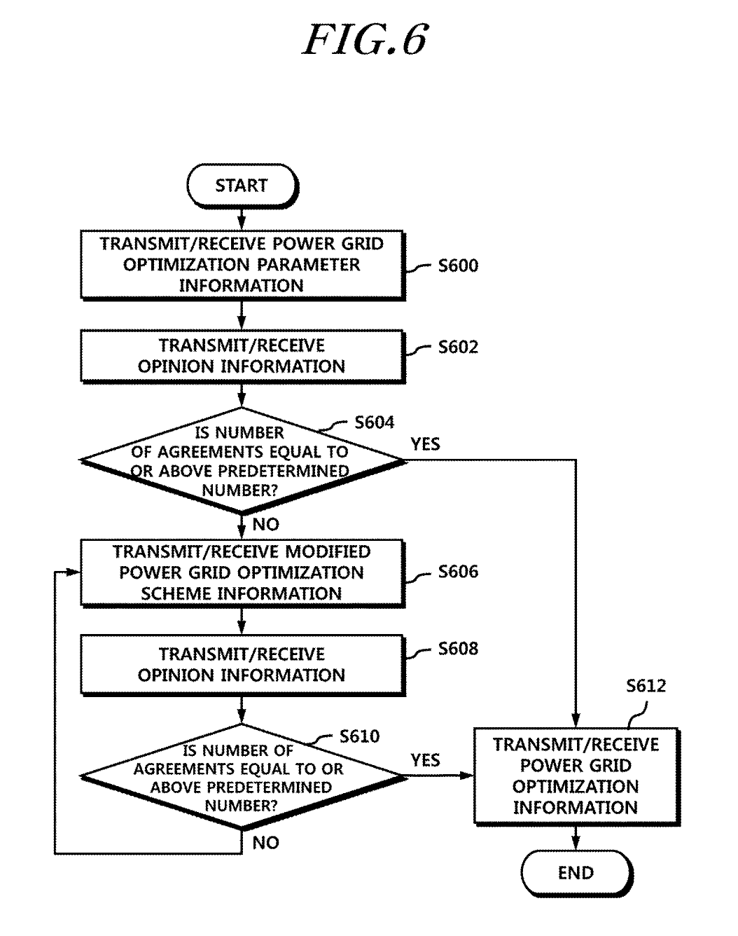

FIG. 6 is a flowchart of a negotiation process in a power grid management system 100 according to an embodiment of the present invention.

One agent device (first agent device 110 in FIG. 3), which has generated power grid optimization scheme information, transmits the power grid optimization scheme information to other agent devices, and the other agent devices receive the power grid optimization scheme information (S600).

The other agent devices, which have received the power grid optimization scheme information, transmit opinion information, which indicates whether they agree with the received power grid optimization scheme information or not, or which indicates agreement with modification, to the one agent device (first agent device 110 in FIG. 3), which is the sender (S602).

When the one agent device (first agent device 110 in FIG. 3) confirms, through a process of checking the opinion information, agreements of at least a predetermined proportion or a predetermined number among the entire agent devices (YES in S604), the one agent device confirms the power grid optimization scheme information, which has been agreed with, as power grid optimization information and transmits the confirmed power grid optimization information to the other agent devices (S612).

When the one agent device (first agent device 110 in FIG. 3) does not confirm, through the process of checking the opinion information, agreements of at least a predetermined proportion or a predetermined number among the entire agent devices (NO in S604), the one agent device (first agent device 110 in FIG. 3) transmits modified power grid optimization scheme information to the other agent devices (S606).

After receiving the modified power grid optimization scheme information, the other agent devices transmit opinion information, which indicates whether they agree with the received modified power grid optimization scheme information or not, or which indicates agreement with modification, to the one agent device (first agent device 110 in FIG. 3), which is the sender (S608).

When the one agent device (first agent device 110 in FIG. 3) confirms, through the process of checking the opinion information, agreements of at least a predetermined proportion or a predetermined number among the entire agent devices (YES in S610), the one agent device confirms the modified power grid optimization scheme information, which has been agreed with, as power grid optimization information and transmits the confirmed power grid optimization information to the other agent devices (S612).

When the one agent device (first agent device 110 in FIG. 3) does not confirm, through the process of checking the opinion information, agreements of at least a predetermined proportion or a predetermined number among the entire agent devices (NO in S610), the one agent device (first agent device 110 in FIG. 3) returns to the step (S606) of transmitting modified power grid optimization scheme information to the other agent devices.

In order to generate modified power grid optimization scheme information, one agent device (first agent device 110 in FIG. 3) additionally generates different power grid optimization scheme information, which further includes a priority value, in the step (S320) of generating power grid optimization scheme information; when agreements of at least a predetermined proportion or a predetermined number are not confirmed on the basis of opinion information received from the other agent devices, the one agent device can generate power grid optimization scheme information, which has a higher priority value among different power grid optimization scheme information, as modified power grid optimization scheme information and transmit the generated information to the other agent devices, in the step (S330) of proceeding with the negotiation process.

When power grid optimization information is confirmed as a result of such a negotiation process, one agent device (first agent device 110 in FIG. 3) transmits the power grid optimization information to the other agent devices (S340).

Then, each agent device operates the power grid according to the transmitted/received power grid optimization information and optimizes the power grid.

A method for generating power grid optimization information by a power grid management system 100 according to an embodiment of the present invention has been described above. Hereinafter, an agent device 110 configured to generate power grid optimization information according to an embodiment of the present invention will be described.

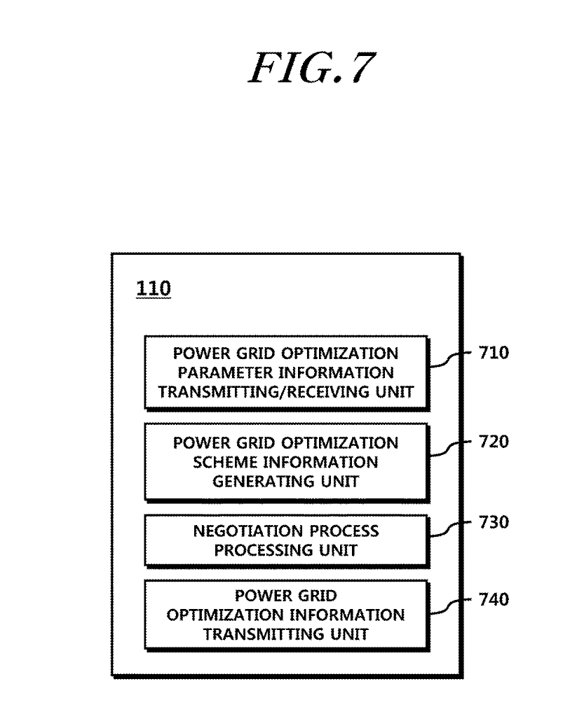

FIG. 7 is an internal block diagram of an agent device 110 configured to generate power grid optimization information according to an embodiment of the present invention.

Referring to FIG. 7, the agent device 110 may include a power grid optimization parameter information transmitting/receiving unit 710, a power grid optimization scheme information generating unit 720, a negotiation process processing unit 730, a power grid optimization information transmitting unit 740, etc.

The power grid optimization parameter information transmitting/receiving unit 710 exchanges power grid optimization parameter information with other agent devices. Power grid optimization parameter information, which is held by the agent device 110, is transmitted to other agent devices, and power grid optimization information is received from the other agent devices.

The power grid optimization parameter information may include at least one of power consuming device information, power supplying device information, and power supply unit price information; the power consuming device information may include information regarding the state of at least one power consuming device, which constitutes the power grid, and power consumption prediction information; and the power supplying device information may include information regarding the state of at least one power supplying device, which constitutes the power grid, and power supply prediction information.

The power grid optimization scheme information generating unit 720 generates power grid optimization scheme information according to the exchanged power grid optimization parameter information. The power grid optimization scheme information generating unit 720 can generate the power grid optimization scheme information so as to minimize the power supply cost of the power grid.

The negotiation process processing unit 730 proceeds with a negotiation process with the other agent devices in connection with the generated power grid optimization scheme information. The negotiation process proceeds in the following manner: power grid optimization scheme information or modified power grid optimization scheme information is transmitted to other agent devices, and opinion information, which indicates whether they agree with the transmitted power grid optimization scheme information or not, or which indicates agreement with modification, is received from the other agent devices.

When agreements of at least a predetermined proportion or a predetermined number are confirmed on the basis of the opinion information, the negotiation process processing unit 730 can confirm the transmitted power grid optimization scheme information or modified power grid optimization scheme information as power grid optimization information.

In connection with generating modified power grid optimization scheme information, the power grid optimization scheme information generating unit 720 additionally generates different power grid optimization scheme information, which further includes a priority value; when agreements of at least a predetermined proportion or a predetermined number are not confirmed on the basis of opinion information, the negotiation process processing unit 730 can transmit power grid optimization scheme information, which has a higher priority value among different power grid optimization scheme information, as modified power grid optimization scheme information to the other agent devices.

When power grid optimization information is confirmed as a result of the negotiation process, the power grid optimization information transmitting unit 740 transmits the power grid optimization information to the other agent devices.

An agent device 110 configured to generate power grid optimization information according to an embodiment of the present invention has been described above, and a method for generating power grid optimization information by an agent device 110 configured to generate power grid optimization information according to an embodiment of the present invention will now be described. The method for generating power grid optimization information according to an embodiment of the present invention, which will now be described, can be entirely performed by the agent device 110 according to an embodiment of the present invention illustrated in FIG. 7.

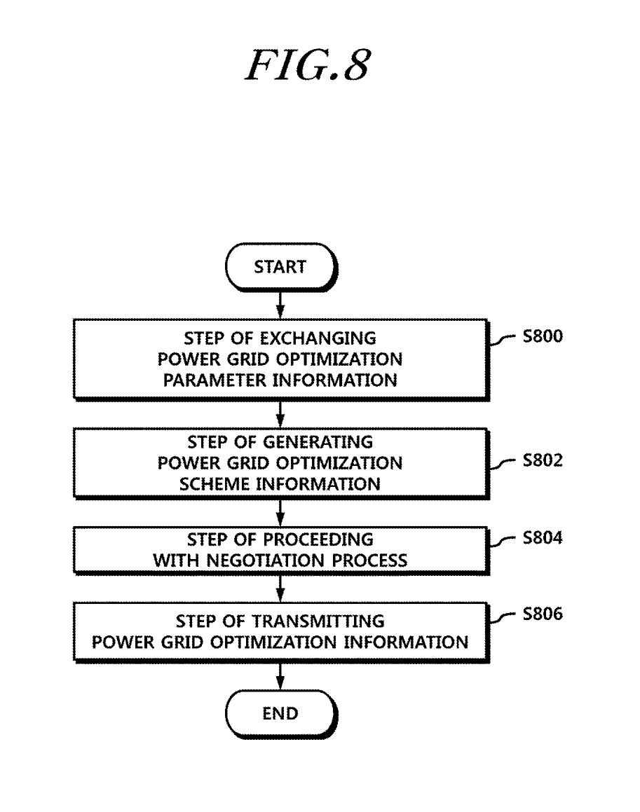

FIG. 8 is a flowchart of a method for generating power grid optimization information by an agent device according to an embodiment of the present invention.

Referring to FIG. 8, an agent device 110 exchanges power grid optimization parameter information with other agent devices (S800). The agent device 110 then generates power grid optimization scheme information according to the exchanged power grid optimization parameter information (S802).

The agent device 110 proceeds with a negotiation process with other agent devices in connection with the power grid optimization scheme information (S804). The negotiation process proceeds in the following manner: power grid optimization scheme information or modified power grid optimization scheme information is transmitted to other agent devices, and opinion information, which indicates whether they agree with the transmitted power grid optimization scheme information or not, or which indicates agreement with modification, is received from the other agent devices.

When power grid optimization information is confirmed as a result of the negotiation process, the agent device 110 transmits the power grid optimization information to the other agent devices (S806).

Although a method for generating power grid optimization information according to an embodiment of the present invention has been described as being performed in a procedure as illustrated in FIG. 8, this is solely for convenience of description, and it is also possible, without departing from the essential idea of the present invention, to change the procedure of performing each step according to the implementation scheme, to integrate at least two steps, or to separate one step into at least two steps and perform them.

Even if it was described above that all of the components of an embodiment of the present invention are coupled as a single unit or coupled to be operated as a single unit, the present invention is not necessarily limited to such an embodiment. That is, at least two elements of all structural elements may be selectively joined and operate without departing from the scope of the present invention. In addition, although each of the components may be implemented as an independent hardware, some or all of the components may be selectively combined with each other, so that they can be implemented as a computer program having one or more program modules for executing some or all of the functions combined in one or more pieces of hardware. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, or the like may be employed as the storage medium of a computer program.

In addition, since terms, such as “including,” “comprising,” and “having” mean that one or more corresponding components may exist unless they are specifically described to the contrary, it shall be construed that one or more other components can be included. All the terms that are technical, scientific or otherwise agree with the meanings as understood by a person skilled in the art unless defined to the contrary. Common terms as found in dictionaries should be interpreted in the context of the related technical writings not too ideally or impractically unless the present disclosure expressly defines them so.

Although the embodiments of the present invention have been described for illustrative purposes, those skilled in the art will appreciate that various modifications, additions and substitutions are possible, without departing from the scope and spirit of the invention. Accordingly, the embodiments disclosed in the present invention are merely to not limit but describe the technical spirit of the present invention. Further, the scope of the technical spirit of the present invention is limited by the embodiments. The scope of the present invention shall be construed on the basis of the accompanying claims in such a manner that all of the technical ideas included within the scope equivalent to the claims belong to the present invention.

### CROSS-REFERENCE TO RELATED APPLICATION

If applicable, this application claims priorities under 35 U.S.C §119(a) of Patent Application No. 10-2012-0095202, filed on Aug. 29, 2012 in Korea, the entire contents of which are incorporated herein by reference. In addition, this non-provisional application claims priorities in countries, other than the U.S., with the same reason based on the Korean Patent Applications, the entire contents of which are hereby incorporated by reference.

1. A method for generating power grid optimization information in a power grid management system comprising a plurality of agent devices, the method comprising:
exchanging power grid optimization parameter information, which is held by each of the plurality of agent devices, between the plurality of agent devices;
generating power grid optimization scheme information according to the exchanged power grid optimization parameter information by one agent device;
proceeding with a negotiation process between the plurality of agent devices in connection with the power grid optimization scheme information; and
transmitting, when power grid optimization information is confirmed as a result of the negotiation process, the power grid optimization information to other agent devices by the one agent device, wherein
the negotiation process proceeds in such a manner that the one agent device transmits the power grid optimization scheme information or modified power grid optimization scheme information to the other agent devices, and the other agent devices reply to the one agent device with opinion information indicating whether the other agent devices agree with the received optimization scheme information or not or indicating agreement with modification.

2. The method as claimed in claim 1, wherein the power grid optimization parameter information comprises at least one of power consuming device information, power supplying device information, and power supply unit price information,
the power consuming device information comprises information regarding the state of at least one power consuming device, which constitutes the power grid, and power consumption prediction information, and
the power supplying device information comprises information regarding the state of at least one power supplying device, which constitutes the power grid, and power supply prediction information.

3. The method as claimed in claim 1, wherein, in the generating power grid optimization scheme information, the one agent device generates the power grid optimization scheme information so that the power supply cost of the power grid is minimized.

4. The method as claimed in claim 1, wherein, in the proceeding with a negotiation process, when agreements of at least a predetermined proportion or a predetermined number are confirmed from the opinion information, the power grid optimization scheme information transmitted by the one agent device or modified power grid optimization scheme information is confirmed as the power grid optimization information.

5. The method as claimed in claim 4, wherein, in the generating power grid optimization scheme information, the one agent device additionally generates different power grid optimization scheme information, which further comprises a priority value, and
in the proceeding with a negotiation process, when agreements of at least a predetermined proportion or a predetermined number are not confirmed from the opinion information, optimization scheme information having a higher priority value among the different power grid optimization scheme information is transmitted to the other agent devices as the modified power grid optimization scheme information.

6. An agent device for generating power grid optimization information in a power grid management system comprising a plurality of agent devices, the agent device comprising:
a power grid optimization parameter information transmitting/receiving unit configured to exchange power grid optimization parameter information with other agent devices;
a power grid optimization scheme information generating unit configured to generate power grid optimization scheme information according to the exchanged power grid optimization parameter information;
a negotiation process processing unit configured to proceed with a negotiation process with the other agent devices in connection with the power grid optimization scheme information; and
a power grid optimization information transmitting unit configured to transmit, when power grid optimization information is confirmed as a result of the negotiation process, the power grid optimization information to the other agent devices, wherein
the negotiation process proceeds in such a manner that the power grid optimization scheme information or modified power grid optimization scheme information is transmitted to the other agent devices, and opinion information indicating whether the other agent devices agree with the transmitted optimization scheme information or not or indicating agreement with modification is received from the other agent devices.

7. The agent device as claimed in claim 6, wherein the power grid optimization parameter information comprises at least one of power consuming device information, power supplying device information, and power supply unit price information,
the power consuming device information comprises information regarding the state of at least one power consuming device, which constitutes the power grid, and power consumption prediction information, and
the power supplying device information comprises information regarding the state of at least one power supplying device, which constitutes the power grid, and power supply prediction information.

8. The agent device as claimed in claim 6, wherein the power grid optimization scheme information generating unit is configured to generate the power grid optimization scheme information so that the power supply cost of the power grid is minimized.

9. The agent device as claimed in claim 6, wherein the negotiation process processing unit is configured to confirm, when agreements of at least a predetermined proportion or a predetermined number are confirmed from the opinion information, the transmitted power grid optimization scheme information or the modified power grid optimization scheme information as the power grid optimization information.

10. The agent device as claimed in claim 8, wherein the power grid optimization scheme information generating unit is configured to additionally generate different power grid optimization scheme information, which further comprises a priority value, and
the negotiation process processing unit is configured to transmit, when agreements of at least a predetermined proportion or a predetermined number are not confirmed from the opinion information, optimization scheme information having a higher priority value among the different power grid optimization scheme information to the other agent devices as the modified power grid optimization scheme information.

11. A method for generating power grid optimization information in a power grid management system, which comprises a plurality of agent devices, by an agent device, the method comprising:
exchanging power grid optimization parameter information with other agent devices;
generating power grid optimization scheme information according to the exchanged power grid optimization parameter information;
proceeding with a negotiation process with the other agent devices in connection with the power grid optimization scheme information; and
transmitting, when power grid optimization information is confirmed as a result of the negotiation process, the power grid optimization information to other agent devices, wherein
the negotiation process proceeds in such a manner that the power grid optimization scheme information or modified power grid optimization scheme information is transmitted to the other agent devices, and opinion information indicating whether the other agent devices agree with the transmitted optimization scheme information or not or indicating agreement with modification is received from the other agent devices.
